(19) United States
(12) Patent Application Publication
(10) Pub. No.: US 2024/0391147 A1
(43) Pub. Date: Nov. 28, 2024

(54) METHOD FOR MANUFACTURING GOLF BALL

(71) Applicant: BRIDGESTONE SPORTS CO., LTD., Tokyo (JP)

(72) Inventor: Hideo WATANABE, Chichibushi (JP)

(73) Assignee: BRIDGESTONE SPORTS CO., LTD., Tokyo (JP)

(21) Appl. No.: 18/651,806

(22) Filed: May 1, 2024

(30) Foreign Application Priority Data
May 22, 2023 (JP) 2023-083711

(51) Int. Cl. B29C 45/14; B29C 45/16; B29C 45/72; B29K 75/00; B29K 96/00; B29L 31/54

(52) U.S. Cl. CPC B29C 45/14819; B29C 45/1671; B29C 45/7207; B29K 2075/00; B29K 2096/005; B29L 2031/546

(57) ABSTRACT

The present invention is a method for manufacturing a golf ball including a core, at least one intermediate layer, and a cover, the core being formed of a rubber material, the intermediate layer being formed of a resin composition, and the cover being formed of a urethane resin material, the method including:
a step (1) of forming an intermediate layer-encased sphere by encasing the core with the at least one intermediate layer;
a step (2) of subjecting the intermediate layer-encased sphere to a heat treatment at a temperature of at least a melting point of a base resin of the resin composition of the intermediate layer and less than 160° C.; and
a step (3) of thereafter forming a cover-encased sphere by encasing the intermediate layer- encased sphere with the cover.

### CROSS-REFERENCE TO RELATED APPLICATIONS

This non-provisional application claims priority under 35 U.S.C. § 119(a) on Patent Application No. 2023-083711 filed in Japan on May 22, 2023, the entire contents of which are hereby incorporated by reference.

### TECHNICAL FIELD

The present invention relates to a method for manufacturing a golf ball including a rubber core, at least one resin intermediate layer, and a urethane resin cover.

### BACKGROUND ART

It has been previously known that a superior flight is obtained by designing a ball structure in which a ball has a low spin rate on full shots with a driver (W #1) or the like. In addition, in recent years, development and research of balls for obtaining a spin rate on approach shots at a high level have been continued in order to enhance playability in the short game. As an example, golf balls described in Patent Documents 1 and 2 have been proposed. These golf balls have a layer structure that is hard on the inside and soft on the outside in which an intermediate layer is interposed between a core and an outermost layer, and the intermediate layer on the inside is set to a higher hardness than the cover on the outside. That is, by providing a resin material harder than the cover between the rubbery elastic core and the soft cover material, it is possible to simultaneously solve the task of lowering a spin rate on full shots and the task of maintaining approach controllability in the short game at a high level.

However, in recent years, it is required to obtain a desired distance by lowering the spin rate of a ball on full shots with not only the driver (W #1), but also a middle or higher iron. Therefore, increasing the level of lowering the spin rate on full shots with an iron has become a new issue. However, as described above, in a three-piece or more multilayer golf ball having a layer structure that is hard on the inside and soft on the outside, further increasing the number of layers increases the number of steps in the manufacturing process of the golf ball, leading to high cost. In addition, as the number of layers increases, a possibility of eccentricity in the inner layer structure of the ball centered on the core increases, which may make it difficult to manufacture a high-quality ball. In addition, there is a limit to appropriately adjusting the hardness gradient (hardness profile) from the inside to the outside of the rubber core, the material type and material hardness of the intermediate layer and the cover, and the thickness of each layer, which have already been proposed in many patent publications.

Therefore, there is room for improvement in modifying the physical properties of the ball by devising the manufacturing process, that is, increasing the distance by lowering the spin rate of the ball on shots with a driver, increasing the spin rate of the ball in the short game, and further lowering the spin rate of the ball on full shots with an iron, not by selecting and adjusting the materials and thicknesses/hardnesses of the conventionally-used core, intermediate layer, and cover.

For example, Patent Documents 3 to 6 are cited as conventional examples in which a core or a ball is subjected to a heat treatment. In Patent Document 3 and Patent Document 4, a core obtained by vulcanizing a rubber material is subjected to a heat treatment under certain conditions to reduce volatile substances contained in the core. In addition, Patent Document 5 proposes that a golf ball excellent in rebound performance can be manufactured without impairing the appearance such as deformation of dimples by heat-treating an intermediate layer-encased sphere having an intermediate layer formed around a core at 40 to 80° C. Further, Patent Document 6 describes a method for customizing a golf ball by heating the ball to a temperature selected in advance to change the physical properties of the ball. However, among these Patent Documents 3 to 6, Patent Documents 3 and 4 heat-treat the core for reducing volatile substances contained in the core, and Patent Document 6 heat-treats the finished golf ball encased with a cover. In Patent Document 5, the object to be heat-treated is the intermediate layer-encased sphere, but the temperature of the heat treatment is as low as 40 to 80° C. All of the golf balls described in Patent Documents 3 to 6 have contents different from the tasks of lowering the spin rate of the ball on shots with a driver, increasing the spin rate of the ball in the short game, and lowering the spin rate of the ball on full shots with an iron, and there is room for looking for and considering methods other than these heat treatments.

### CITATION LIST

Patent Document 1: JP-A H09-239068

Patent Document 2: JP-A 2002-000765

Patent Document 3: JP-A 2017-225686

Patent Document 4: JP-A 2017-225682

Patent Document 5: JP-A 2004-159840

Patent Document 6: JP-A 2011-167508

### SUMMARY OF THE INVENTION

The present invention has been made in view of the above circumstances, and an object of the present invention is to provide a method for manufacturing a golf ball capable of improving flight performance by exhibiting sufficient spin rate-lowering characteristics on full shots of a golf ball with not only a driver (W #1) but also an iron.

As a result of intensive studies to achieve the above object, the present inventor has found that in a manufacturing process for a golf ball including a core, an intermediate layer, and a cover, by encasing the core with the intermediate layer to form an intermediate layer-encased sphere, then subjecting the intermediate layer-encased sphere to a heat treatment at a temperature of at least the melting point of a base resin of a resin composition of the intermediate layer and less than 160° C., and measuring the surface hardness of the obtained intermediate layer-encased sphere, the surface hardness of the intermediate layer-encased sphere is unexpectedly increased, and the spin rate on full shots of the finished golf ball with an iron is lowered, and thus has completed the present invention.

That is, the present invention is characterized in that a predetermined heat treatment is performed, not on a finished golf ball as in Patent Document 6 described above, but on the intermediate layer-encased sphere after obtaining the intermediate layer-encased sphere in which the intermediate layer is formed around the core during the manufacturing process of the golf ball. This method controls the crystallinity of a crystal phase of the intermediate layer (resin layer) in the intermediate layer-encased sphere to increase the surface hardness of the intermediate layer-encased sphere, so that the spin rate on full shots with an iron is lowered. When the heat treatment is performed on the golf ball after finishing the ball as in Patent Document 6, it is presumed that the degree of control of the crystallinity of the crystal phase in the intermediate layer (resin layer) is smaller than that in the present invention in which the intermediate layer-encased sphere is directly heat-treated, and the spin rate-lowering effect on full shots becomes inadequate. In addition, when the heat treatment is performed after finishing the golf ball, dimples change in shape due to the heat treatment, and there is a risk that the intended aerodynamic properties may not be obtained. In contrast, in the case of the present invention, in which the intermediate layer-encased sphere is directly heat-treated, there is no possibility of dimple damage due to the heat treatment.

Accordingly, the present invention provides a method for manufacturing a golf ball including
a core, at least one intermediate layer, and a cover, the core being formed of a rubber material, the intermediate layer being formed of a resin composition, and the cover being formed of a urethane resin material, the method including:
a step (1) of forming an intermediate layer-encased sphere by encasing the core with the at least one intermediate layer;

a step (2) of subjecting the intermediate layer-encased sphere to a heat treatment at a temperature of at least a melting point of a base resin of the resin composition of the intermediate layer and less than 160° C.; and
a step (3) of thereafter forming a cover-encased sphere by encasing the intermediate layer-encased sphere with the cover.

In a preferred embodiment of the manufacturing method according to the invention, in the step (2), the temperature of the heat treatment on the intermediate layer-encased sphere is 90 to 150° C.

In another preferred embodiment of the inventive manufacturing method, in the step (2), a time of the heat treatment on the intermediate layer-encased sphere is 3 to 60 minutes.

In yet another preferred embodiment, in the step (1), the intermediate layer-encased sphere is formed by injection molding the resin composition of the intermediate layer around the core.

In still another preferred embodiment, in the step (3), the cover-encased sphere is formed by injection molding the urethane resin material of the cover around the intermediate layer-encased sphere.

In a further preferred embodiment, the base resin of the resin composition of the intermediate layer is an ionomer resin.

### ADVANTAGEOUS EFFECTS OF THE INVENTION

With the golf ball according to the present invention, it is possible to increase the distance by not only lowering the spin rate of the ball on shots with a driver, but also lowering the spin rate of the ball on full shots with an iron, and it is further possible to improve approach controllability by maintaining the spin rate of the ball in the short game at a high level.

### DETAILED DESCRIPTION OF THE INVENTION

Hereinafter, the present invention is described in more detail.

A method for manufacturing a golf ball of the present invention is a method for manufacturing a golf ball including a core, at least one intermediate layer, and a cover.

The core is formed of a rubber material. It is preferable that the basic performance of the core-forming rubber material used in the present invention, such as hardness and rebound, is not deteriorated even when the core-forming rubber material is heated at a temperature of at least the melting point of a resin material of the intermediate layer described later. In addition, it is preferable that the core-forming rubber material used in the present invention may ensure a sufficient rebound required for the golf ball. Furthermore, a core having a predetermined hardness gradient (hardness profile) inside may be obtained depending on selection of the formulation contents of the rubber material and vulcanization conditions. As such formulations of the core, specifically, the core is preferably formed of a thermally molded product of a rubber composition containing at least the following components (A) to (D):
(A) base rubber
(B) organic peroxide
(C) water
(D) sulfur.

The base rubber of the above component (A) is not particularly limited, although polybutadiene is particularly preferably used. As the type of polybutadiene, a commercially available product may be used, and examples thereof include Trade name “BR 01”, “BR 51”, “BR 730”, and “BR T700” (manufactured by ENEOS Materials Corporation). The proportion of polybutadiene in the base rubber is preferably at least 60 wt %, and more preferably at least 80 wt %. In addition to the polybutadiene, other rubber components are included in the base rubber as long as the effect of the present invention is not impaired. Examples of the rubber component other than the polybutadiene include a polybutadiene other than the polybutadiene described above, and other diene rubbers such as styrene-butadiene rubber, natural rubber, isoprene rubber, and ethylene-propylene-diene rubber.

The organic peroxide (B) is used as a crosslinking initiator. Specifically, an organic peroxide having a relatively high thermal decomposition temperature is preferably used. Specifically, a high-temperature organic peroxide having a one-minute half-life temperature of about 165 to 185° C. is used, and examples thereof include dialkyl peroxides. Examples of the dialkyl peroxides include dicumyl peroxide (“Percumyl D” manufactured by NOF Corporation), 2,5-dimethyl-2,5-di(t-butylperoxy) hexane (“Perhexa 25B” manufactured by NOF Corporation), and a di(2-t-butylperoxyisopropyl) benzene (“Perbutyl P” manufactured by NOF Corporation), and dicumyl peroxide may be suitably used. These may be used singly, or two or more may be used in combination. The half-life is one of the indices indicating a degree of a decomposition rate of the organic peroxide, and is indicated by a time required for the original organic peroxide to be decomposed and its active oxygen amount to reach 1/2. A vulcanization temperature in the core-forming rubber composition is typically within a range of 120 to 190° C., and in that range, an organic peroxide having a one-minute half-life temperature of a high temperature, which is about 165 to 185° C., is thermally decomposed relatively slowly. With the rubber composition of the present invention, by adjusting the amount of free radicals produced, which increases with the lapse of a vulcanization time, a core is obtained that is a rubber cross-linked product having a specific internal hardness shape.

The water (C), although not particularly limited, may be distilled water or tap water, but it is particularly suitable to employ distilled water free of impurities. The compounding amount of the water included per 100 parts by weight of the base rubber is preferably at least 0.1 part by weight, and more preferably at least 0.3 part by weight, and the upper limit is preferably not more than 5 parts by weight, and more preferably not more than 4 parts by weight.

By blending the water (water-containing material) directly into the core material, decomposition of the organic peroxide during the core formulation may be promoted. In addition, it is known that the decomposition efficiency of the organic peroxide in the core-forming rubber composition changes depending on temperature, and the decomposition efficiency increases as the temperature becomes higher than a certain temperature. If the temperature is too high, the amount of decomposed radicals becomes too large, and the radicals are recombined or deactivated. As a result, fewer radicals act effectively in crosslinking. Here, when decomposition heat is generated by the decomposition of the organic peroxide at the time of core vulcanization, a temperature near the core surface is maintained at substantially the same level as a temperature of a vulcanization mold, but a temperature around the core center is considerably higher than the mold temperature due to an accumulation of decomposition heat by the organic peroxide decomposing from the outside. If the water is directly included in the core, the water acts to promote the decomposition of the organic peroxide, so that the radical reactions as described above may be changed at the core center and the core surface. That is, the decomposition of the organic peroxide is further promoted near the core center, and the deactivation of radicals is further promoted, so that the amount of active radicals is further reduced, and as a result, a core may be obtained in which the crosslink densities at the core center and the core surface differ markedly, and the dynamic viscoelasticity of the core center portion is different.

By using the sulfur (D), a difference in hardness between the inside and the outside of the core may be increased. Specific examples of the sulfur (D) include Trade names “SANMIX S-80N” (manufactured by Sanshin Chemical Industry Co., Ltd.) and “SULFAX-5” (manufactured by Tsurumi Chemical Industry Co., Ltd.). The compounding amount of the sulfur may exceed 0 part by weight, may be preferably at least 0.005 part by weight, and more preferably at least 0.01 part by weight per 100 parts by weight of the base rubber. In addition, the upper limit of the compounding amount is not particularly limited, although the upper limit is preferably not more than 0.1 part by weight, more preferably not more than 0.05 part by weight, and even more preferably not more than 0.03 part by weight. If the compounding amount of the sulfur is too large, the rebound may be greatly reduced, or a durability on repeated impact may worsen.

As for the blending proportion of the above components (C) and (D), the weight ratio of (D)/(C) is preferably at least 0.02, more preferably at least 0.03, and even more preferably at least 0.04. The upper limit is preferably not more than 0.20, more preferably not more than 0.16, and even more preferably not more than 0.12. If the weight ratio deviates from the above numerical ranges, it becomes difficult to achieve the intended hardness profile of the core, and it may be impossible to achieve both a superior distance by lowering the spin rate on full shots and good durability on repeated impact. The above component (D) means the weight of a sulfur component contained in a sulfur product, not the weight of the product itself.

In the above rubber composition, a co-crosslinking agent (E) and an inert filler (F) may be included in addition to the components (A) to (D) described above, and an antioxidant or an organosulfur compound may be included as necessary. These components are described in detail below.

(E) Examples of the co-crosslinking agent include an unsaturated carboxylic acid and a metal salt of an unsaturated carboxylic acid. Specific examples of the unsaturated carboxylic acid include acrylic acid, methacrylic acid, maleic acid, fumaric acid, or the like, and in particular, acrylic acid and methacrylic acid are suitably used. The metal salt of the unsaturated carboxylic acid is not particularly limited, and examples thereof include those obtained by neutralizing the unsaturated carboxylic acid with a desired metal ion. Specific examples thereof include zinc salts and magnesium salts such as methacrylic acid and acrylic acid, and in particular, zinc acrylate is suitably used.

The unsaturated carboxylic acid and/or the metal salt thereof is typically blended in an amount of at least 5 parts by weight, preferably at least 9 parts by weight, and even more preferably at least 13 parts by weight, and the upper limit is typically not more than 60 parts by weight, preferably not more than 50 parts by weight, and even more preferably not more than 40 parts by weight per 100 parts by weight of the base rubber. If the compounding amount is too large, the core may become too hard, giving the ball an unpleasant feel at impact, and if the compounding amount is too small, the rebound may become low.

As the inert filler (F), for example, zinc oxide, barium sulfate, calcium carbonate, or the like may be suitably used. These may be used singly, or two or more may be used in combination. The compounding amount of the inert filler is preferably at least 1 part by weight, and more preferably at least 5 parts by weight, and the upper limit is preferably not more than 30 parts by weight, more preferably not more than 25 parts by weight, and even more preferably not more than 20 parts by weight per 100 parts by weight of the base rubber. The compounding amount of the inert filler is adjusted to adjust the specific gravity of the core. If the compounding amount is too small, it may not be possible to obtain an appropriate weight and a suitable rebound.

Furthermore, an antioxidant may be included as necessary. For example, as a commercially available product, Nocrac MB, Nocrac NS-6, and Nocrac NS-30 (manufactured by Ouchi Shinko Chemical Industrial Co., Ltd.), and YOSINOX 425 (manufactured by Yoshitomiyakuhin Corporation) may be used. These may be used singly, or two or more may be used in combination.

The compounding amount of the antioxidant is preferably at least 0 part by weight, more preferably at least 0.05 part by weight, and particularly preferably at least 0.1 part by weight, and the upper limit is preferably not more than 3 parts by weight, more preferably not more than 2 parts by weight, particularly preferably not more than 1 part by weight, and most preferably not more than 0.5 part by weight per 100 parts by weight of the base rubber. If the compounding amount is too large or too small, it may not be possible to obtain suitable rebound and durability.

In addition, an organosulfur compound may be included in the core in order to impart a good rebound. The organosulfur compound is not particularly limited as long as it is able to improve the rebound of the golf ball. Examples thereof include thiophenols, thionaphthols, halogenated thiophenols, and metal salts thereof. More specifically, the examples include pentachlorothiophenol, pentafluorothiophenol, pentabromothiophenol, p-chlorothiophenol, a zinc salt of pentachlorothiophenol, a zinc salt of pentafluorothiophenol, a zinc salt of pentabromothiophenol, a zinc salt of p-chlorothiophenol, and any of the following having 2 to 4 sulfur atoms: diphenylpolysulfide, dibenzylpolysulfide, dibenzoylpolysulfide, dibenzothiazoylpolysulfide, and dithiobenzoylpolysulfide. In particular, the zinc salt of pentachlorothiophenol is preferably used. The compounding amount of the organosulfur compound is preferably at least 0 parts by weight, more preferably at least 0.05 part by weight, and even more preferably at least 0.1 part by weight, and the upper limit is preferably not more than 5 parts by weight, more preferably not more than 3 parts by weight, and even more preferably not more than 2.5 parts by weight per 100 parts by weight of the base rubber. If the compounding amount is too large, the effect of improving the rebound (in particular, shots with W #1) may not be expected any more, and the core may be too soft or the feel at impact may be poor. On the other hand, if the compounding amount is too small, the effect of improving the rebound may not be expected.

The core may be manufactured by vulcanizing and curing the rubber composition containing the above components. For example, a molded body may be manufactured by intensively mixing the rubber composition using a mixing apparatus such as a Banbury mixer or a roll mill, subsequently compression molding or injection molding the mixture using a core mold, and curing the resulting molded body by appropriately heating it at a temperature sufficient for the organic peroxide or the co-crosslinking agent to act, such as at a temperature of 100 to 200° C., and preferably at a temperature of 140 to 180° C., for 10 to 40 minutes.

In the present invention, the core may be formed as a single layer or a plurality of layers of rubber cores. However, in the case of a plurality of layers, layer separation at the interface may arise when the ball is repeatedly struck, possibly leading to durability deterioration.

The diameter of the core is not particularly limited, although the diameter is preferably at least 35.5 mm, more preferably at least 37.5 mm, and even more preferably at least 38.3 mm. The upper limit is preferably not more than 39.5 mm, more preferably not more than 39.2 mm, and even more preferably not more than 38.8 mm. If the diameter of the core is too small, the actual initial velocity on full shots may become low, and the intended distance may not be attainable, or the feel at impact may be too hard. On the other hand, if the diameter of the core is too large, the durability on repeated impact may worsen.

The deflection (mm) when the core is compressed under a final load of 1,275 N (130 kgf) from an initial load of 98 N (10 kgf) is, although not particularly limited, preferably at least 2.5 mm, more preferably at least 2.7 mm, and even more preferably at least 2.9 mm. The upper limit is preferably not more than 3.5 mm, more preferably not more than 3.4 mm, and even more preferably not more than 3.3 mm. If the deflection of the core is too small, that is, the core is too hard, the spin rate of the ball may rise excessively, resulting in a poor flight, or the feel at impact may be too hard. On the other hand, if the deflection of the core is too large, that is, the core is too soft, the ball rebound may become too low, resulting in a poor flight, the feel at impact may be too soft, or the durability to cracking on repeated impact may worsen.

Next, the core hardness profile is described. The hardness of the core described below means Shore C hardness. The Shore C hardness is a hardness value measured with a Shore C durometer conforming to the ASTM D2240 standard.

A core center hardness (Cc) is preferably at least 58, more preferably at least 60, and even more preferably at least 62, and the upper limit is preferably not more than 70, more preferably not more than 68, and even more preferably not more than 66. If this value is too large, the feel at impact becomes hard, or the spin rate on full shots may rise, and the intended distance may not be attainable. On the other hand, if the above value is too small, the rebound may become low and a good distance may not be achieved, or the durability to cracking on repeated impact may worsen.

A cross-sectional hardness (Cm) at a midpoint M of the core is not particularly limited, although the cross-sectional hardness (Cm) may be preferably at least 61, more preferably at least 64, and even more preferably at least 67. The upper limit is also not particularly limited, although the upper limit may be preferably not more than 73, more preferably not more than 71, and even more preferably not more than 69. Hardnesses that deviate from these values may lead to undesirable results similar to those described above for the core center hardness (Cc).

Furthermore, a cross-sectional hardness (Cp) at a midpoint between the core center and the midpoint M is not particularly limited, although the cross-sectional hardness (Cp) may be preferably at least 61, more preferably at least 63, and even more preferably at least 65. The upper limit is also not particularly limited, although the upper limit may be preferably not more than 72, more preferably not more than 70, and even more preferably not more than 68. Hardnesses that deviate from these values may lead to undesirable results similar to those described above for the core center hardness (Cc).

A core surface hardness (Cs) is preferably at least 82, more preferably at least 84, and even more preferably at least 86. The upper limit is preferably not more than 92, more preferably not more than 90, and even more preferably not more than 88. If this value is too large, the durability to cracking on repeated impact may worsen, or the feel at impact may be too hard. On the other hand, if the above value is too small, the spin rate on full shots may rise, and the intended distance may not be attainable.

Furthermore, a cross-sectional hardness (Cq) at a midpoint between the core surface and the midpoint M is not particularly limited, although the cross-sectional hardness (Cq) may be preferably at least 75, more preferably at least 77, and even more preferably at least 79. The upper limit is also not particularly limited, although the upper limit may be preferably not more than 85, more preferably not more than 83, and even more preferably not more than 81. Hardnesses that deviate from these values may lead to undesirable results similar to those described above for the core surface hardness (Cs).

A difference (Cs-Cc) between the surface hardness and the center hardness of the core is not particularly limited, although the difference (Cs-Cc) is preferably at least 18, more preferably at least 19, and even more preferably at least 20. On the other hand, the upper limit is not particularly limited, although the upper limit may be preferably not more than 35, more preferably not more than 30, and even more preferably not more than 25. If this value is too small, the spin rate of the ball on full shots may not be lowered. On the other hand, if this value is too large, the actual initial velocity on full shots may become too low, or the durability to cracking on repeated impact may worsen.

In addition, it is preferable to optimize the value of (Cs-Cc)/(Cm-Cc) for the core hardness profile. The value of (Cs-Cc)/(Cm-Cc) is an index value of a hardness difference from the core surface to the core center with respect to a hardness difference from the core center to the midpoint M. The value of (Cs-Cc)/(Cm-Cc) is preferably at least 4, more preferably at least 6, and even more preferably at least 7. The upper limit is preferably not more than 20, more preferably not more than 15, and even more preferably not more than 11. If this value is too small, the spin rate of the ball on full shots may not be lowered. On the other hand, if this value is too large, the actual initial velocity on full shots may become too low, or the durability to cracking on repeated impact may worsen.

The present invention includes a step (1) of forming an intermediate layer-encased sphere by encasing the core with at least one intermediate layer.

The intermediate layer is formed of a resin material. The resin material, although not particularly limited, may employ various thermoplastic resin materials used for golf balls. In the present invention, it is suitable to employ an ionomer resin as a chief material (base resin).

The ionomer resin material suitably contains a high-acid ionomer resin having an unsaturated carboxylic acid content (also referred to as “acid content”) of at least 16 wt %.

The amount of high-acid ionomer resin included per 100 wt % of the resin material is preferably at least 20 wt %, more preferably at least 50 wt %, and even more preferably at least 60 wt %. The upper limit is preferably not more than 100 wt %, more preferably not more than 90 wt %, and even more preferably not more than 85 wt %. If the compounding amount of the high-acid ionomer resin is too small, the spin rate of the ball on full shots may rise, and the distance may not be increased. On the other hand, if the compounding amount of the high-acid ionomer resin is too large, the durability on repeated impact may worsen.

In addition, when an ionomer resin is employed as the base resin, an aspect that uses in admixture a zinc-neutralized ionomer resin and a sodium-neutralized ionomer resin as the base resins is desirable. The blending ratio in terms of zinc-neutralized ionomer resin/sodium-neutralized ionomer resin (weight ratio) is from 5/95 to 95/5, preferably from 10/90 to 90/10, and more preferably from 15/85 to 85/15. If the zinc-neutralized ionomer and the sodium-neutralized ionomer are not included in this ratio, the hardness does not increase, and the rebound of the intermediate layer-encased sphere does not increase. As a result, the spin rate may not be lowered on full shots of the ball, or the durability to cracking on repeated impact may worsen.

In the intermediate layer material, an optional additive may be appropriately included depending on the intended use. For example, various additives such as a pigment, a dispersant, an antioxidant, an ultraviolet absorber, and a light stabilizer may be included. If these additives are included, the compounding amount thereof is preferably at least 0.1 part by weight, and more preferably at least 0.5 part by weight, and the upper limit thereof is preferably not more than 10 parts by weight, and more preferably not more than 4 parts by weight per 100 parts by weight of the base resin.

The material hardness of the intermediate layer on the Shore D hardness scale is preferably at least 62, more preferably at least 64, and even more preferably at least 66. In addition, the upper limit is not particularly limited, although the upper limit may be preferably not more than 72, more preferably not more than 70, and even more preferably not more than 68. The material hardness of the intermediate layer is a Shore D hardness value measured by forming the resin material itself alone into a sheet having a thickness of 2 mm and leaving the sheet for two weeks, and does not mean the hardness of the intermediate layer after a heat treatment in a step (2) described later.

As a method of encasing the core with the resin material of the intermediate layer, for example, the layer-encased sphere may be obtained by injecting the intermediate layer material around the core using an injection mold, or the intermediate layer-encased sphere may be produced in which the core is surrounded by enclosing the core within two half cups pre-molded into hemispherical shapes as the intermediate layer material and molding them under applied heat and pressure. In the present invention, the method in which the intermediate layer is injection-molded around the core using the injection mold is preferably employed because the method has a short molding cycle and is excellent in mass productivity.

Next, the present invention includes a step (2) of subjecting the intermediate layer-encased sphere to a heat treatment at a temperature of at least the melting point of the base resin of a resin composition of the intermediate layer and less than 160° C. The above “melting point” means a temperature at which melting of a base resin solid into a liquid occurs. By performing the heat treatment within the above predetermined temperature range and leaving the intermediate layer-encased sphere at room temperature, the crystallinity of a crystal phase of the intermediate layer (resin layer) encasing the core may be controlled to increase the surface hardness of the intermediate layer-encased sphere.

The lower limit of the temperature of the heat treatment on the intermediate layer-encased sphere is not less than the melting point of the base resin of the resin composition of the intermediate layer, preferably not less than 90° C., and more preferably not less than 100° C. On the other hand, the upper limit of the temperature of the heat treatment is usually less than 160° C., preferably not more than 150° C., and more preferably not more than 140° C. If this temperature is too low, the spin rate-lowering effect of the ball on full shots may not be attainable. In addition, if this temperature is too high, the spin rate of the ball may increase instead, or the rebound as the ball may decrease. When two or more kinds of resins are included in the resin composition of the intermediate layer, the resin having the largest compounding amount is regarded as the base resin.

As the means for the heat treatment, for example, a known drying machine such as a convection drying machine (constant temperature oven) may be used, and the heat treatment may be performed by disposing the intermediate layer-encased sphere in this machine. However, the heat treatment is not particularly limited to this means.

In the above step (2), the time of the heat treatment on the intermediate layer-encased sphere is preferably at least 3 minutes, more preferably at least 10 minutes, and even more preferably at least 20 minutes. The upper limit of the heating time is preferably not more than 60 minutes, more preferably not more than 45 minutes, and even more preferably not more than 30 minutes. If this heating time is too short, the spin rate-lowering effect of the ball on full shots may not be attainable. If this heating time is too long, the rebound as the ball may decrease.

Expressed on the Shore D hardness scale, the surface hardness of the intermediate layer-encased sphere after the above step (2) is preferably at least 68, more preferably at least 70, and even more preferably at least 71, and the upper limit is preferably not more than 79, more preferably not more than 77, and even more preferably not more than 75. If the surface hardness of the intermediate layer-encased sphere is too soft, the spin rate on full shots with an iron may rise excessively so that the distance may not be increased, or the initial velocity of the ball may become low so that the distance on full shots with an iron may not be increased. Also, if the intermediate layer-encased sphere is too hard, the durability to cracking on repeated impact and the feel at impact may worsen.

The thickness of the intermediate layer is preferably at least 0.90 mm, more preferably at least 1.10 mm, and even more preferably at least 1.15 mm. On the other hand, the upper limit is preferably not more than 1.50 mm, more preferably not more than 1.35 mm, and still more preferably not more than 1.25 mm. If the intermediate layer is too thin, the durability to cracking on repeated impact may worsen, or the spin rate on full shots with an iron may rise excessively. On the other hand, if the intermediate layer is too thick, the ball initial velocity may become low, or the feel at impact may worsen.

Next, the present invention includes a step (3) of forming a cover-encased sphere by encasing the intermediate layer-encased sphere with the cover (outermost layer).

A method for obtaining the cover-encased sphere in the present invention is not particularly limited, although, for example, the cover-encased sphere may be obtained by injecting the cover material around the intermediate layer-encased sphere using an injection mold, or the cover-encased sphere may be produced by preparing two half cups pre-molded into hemispherical shapes, enclosing the intermediate layer-encased sphere within these cups, and molding them under applied heat and pressure. In the present invention, the method in which the cover material is injection-molded around the intermediate layer-encased sphere using the injection mold is preferably employed because the method has a short molding cycle and is excellent in mass productivity.

As the cover material, a resin composition containing a urethane resin as a chief material may be employed. In general, an ionomer resin material is widely used as the cover material of a golf ball. However, the ionomer resin material has a poorer scuff resistance, and may have a lower spin rate on approach shots at a hardness equivalent to that of the urethane resin. Among the urethane resin materials, a thermoplastic urethane resin material is preferably used because it is excellent in mass productivity. The softening temperature of a typical thermoplastic urethane resin material to which isocyanate is added is about 140 to 175° C. If a heat treatment is performed at a temperature of at least 140° C. after the formation of the ball, dimples change in shape, and the intended aerodynamic properties may not be attainable.

The cover has a material hardness on the Shore D hardness scale which, although not particularly limited, is preferably at least 35, more preferably at least 40, and even more preferably at least 45, and the upper limit is preferably not more than 60, more preferably not more than 55, and even more preferably not more than 50. If the material hardness is too soft, the spin rate on full shots may rise excessively. On the other hand, if the material hardness is too hard, the ball may not be fully receptive to spin on approach shots, or a scuff resistance may worsen.

The cover has a thickness of preferably at least 0.3 mm, more preferably at least 0.45 mm, and even more preferably at least 0.6 mm. On the other hand, the upper limit in the cover thickness is preferably not more than 1.2 mm, more preferably not more than 1.15 mm, and even more preferably not more than 1.0 mm. When the cover is too thick, the rebound of the ball on full shots may be inadequate or the spin rate may rise excessively. On the other hand, when the cover is too thin, the scuff resistance may worsen or the ball may not be receptive to spin on approach shots and may thus lack sufficient controllability.

A large number of dimples are typically formed on the surface of the outermost layer of the cover, and various treatments such as a surface treatment, stamping, and coating may be further performed on the cover.

The manufactured golf ball (finished product) has a deflection (mm) when compressed under a final load of 1,275 N (130 kgf) from an initial load of 98 N (10 kgf) which is preferably at least 2.1 mm, more preferably at least 2.2 mm, and even more preferably at least 2.4 mm. On the other hand, the deflection upper limit is preferably not more than 2.8 mm, more preferably not more than 2.7 mm, and even more preferably not more than 2.6 mm. When the golf ball deflection is too small, i.e., when the ball is too hard, the spin rate on full shots with an iron may rise excessively, or the feel at impact may be too hard. On the other hand, when the deflection is too large, i.e., when the sphere is too soft, the durability to cracking on repeated impact may worsen.

### EXAMPLES

Hereinafter, the present invention is specifically described with reference to Examples and Comparative Examples, but the present invention is not limited to the following Examples.

### Examples 1 to 4 and Comparative Examples 1 and 2

In each Example, a core composition was adjusted by the rubber formulations containing polybutadiene as a principal component shown in the following Table 1 common to all the Examples, and then vulcanization was performed at 150° C. for 19 minutes to produce a core having a diameter of 38.7 mm.

TABLE 1

| | Common to Examples and |
|---|---|
| Core formulation (pbw) | Comparative Examples |
| Polybutadiene | 100 |
| Zinc acrylate | 36.5 |
| Organic peroxide | 1.0 |
| Sulfur | 0.025 |
| Water | 0.3 |
| Zinc stearate | 2.0 |
| Antioxidant | 0.1 |
| Zinc oxide | 15.9 |
| Zinc salt of pentachlorothiophenol | 0.4 |
| Sulfur content/water (substantial weight | 0.07 |
| ratio) | |

Details of the above formulations are as follows.
Polybutadiene rubber: Trade name “BR T700”, manufactured by ENEOS Materials Corporation
Zinc acrylate: Trade name “ZN-DA85S” (manufactured by Nippon Shokubai Co., Ltd.)
Organic peroxide: Dicumyl peroxide, trade name “Percumyl D” (manufactured by NOF Corporation)
Sulfur: Trade name “SANMIX S-80N” (manufactured by Sanshin Chemical Industry Co., Ltd.), sulfur masterbatch containing 80 wt % of sulfur powder for rubber
Water: Pure water (manufactured by Seiki Co., Ltd.)
Zinc stearate: Trade name “Zinc stearate GP” (manufactured by NOF Corporation)
Antioxidant: 2,2-methylenebis(4-methyl-6-butylphenol), trade name “Nocrac NS-6” (manufactured by Ouchi Shinko Chemical Industrial Co., Ltd.)
Zinc oxide: Trade name “Zinc Oxide Grade 3” (manufactured by Sakai Chemical Industry Co., Ltd.)
Zinc salt of pentachlorothiophenol: Manufactured by FUJIFILM Wako Pure Chemical Corporation

### Formation of Intermediate Layer and Cover (Outermost Layer)

Next, in each Example, the intermediate layer was formed around the core obtained above by an injection molding method using the intermediate layer material No. 1 having the formulations shown in Table 2 to prepare the intermediate layer-encased sphere.

Subsequently, the intermediate layer-encased sphere was subjected to a heat treatment under the temperature and time conditions shown in Table 3 described later, which also shows the surface hardness of the intermediate layer-encased sphere after the heat treatment. As the means for the heat treatment, a constant temperature oven, Trade name “DNF 610” manufactured by Yamato Scientific Co., Ltd. was used, and the heat treatment was performed by disposing 20 of the intermediate layer-encased spheres side by side in the oven.

Subsequently, the cover (outermost layer) was formed around the intermediate layer-encased sphere obtained above by an injection molding method using the cover material No. 2 having the formulations shown in Table 2 to produce the golf ball. At this time, predetermined dimples common to each Example were formed on the surface of the cover.

TABLE 2

| Resin composition | | Melting point | | |
|---|---|---|---|---|
| (pbw) | Metal type | (° C.) | No. 1 | No. 2 |
| Himilan 1706 | Zn | 88 | 15 | |
| AM7318 | Na | 90 | 85 | |
| Trimethylolpropane | | | 1.1 | |
| Titanium oxide | | | | 3 |
| TPU | | | | 100 |

Trade names of chief materials mentioned in the table are as follows.
“Himilan 1706” ionomer resin manufactured by Dow-Mitsui Polychemicals Co., Ltd.
“AM7318” ionomer resin manufactured by Dow-Mitsui Polychemicals Co., Ltd.
“Trimethylolpropane” (TMP) manufactured by Tokyo Chemical Industry Co., Ltd.
“Titanium oxide”, manufactured by Sakai Chemical Industry Co., Ltd.
Trade name “Pandex” ether-type thermoplastic polyurethane (TPU), material hardness (Shore D) 47, manufactured by DIC Covestro Polymer Ltd.

For each resulting golf ball, various physical properties such as internal hardnesses at various positions of the core, outer diameters of the core and each layer-encased sphere, and thicknesses and material hardnesses of each layer are evaluated by the following methods, and are shown in Table 3.

### Diameters of Core and of Intermediate Layer-Encased Sphere

After being temperature-adjusted to 23.9±1° C. for at least three hours in a thermostatic bath, the sphere to be measured is measured in a room at a temperature of 23.9±2° C. Five random places on the surface are measured, and using an average value of these measurements as a measured value of each sphere, an average value for the diameter of 10 such spheres is determined.

### Ball Diameter

After being temperature-adjusted to 23.9±1° C. for at least three hours in a thermostatic bath, the ball to be measured is measured in a room at a temperature of 23.9±2° C. Fifteen random places on a portion with no dimples are measured, and using an average value of these measurements as a measured value of one ball, an average value for the diameter of 10 such balls is determined.

### Core Hardness Profile

The core surface is spherical, but an indenter of a durometer is set substantially perpendicular to the spherical core surface, and a core surface hardness expressed on the Shore C hardness scale is measured in accordance with ASTM D2240. With respect to the core center and a predetermined position of the core, the core is cut into hemispheres to obtain a flat cross-section, the hardness is measured by perpendicularly pressing the indenter of the durometer against the center portion and the predetermined positions shown in Table 3, and the hardness at the center and each position are shown as Shore C hardness values. For the measurement of the hardness, a P2 Automatic Rubber Hardness Tester manufactured by Kobunshi Keiki Co., Ltd. equipped with a Shore C durometer is used. For the hardness value, a maximum value is read. All measurements are carried out in an environment of 23±2° C. The numerical values in Table 3 are Shore C hardness values.

### Compressive Deformations (Deflections) of Core, Intermediate Layer-Encased Sphere, and Ball

Each of the target spheres is compressed at a temperature of 23±1° C. and a speed of 10 mm/s, and a compressive deformation (mm) of the target sphere when compressed under a final load of 1,275 N (130 kgf) from an initial load of 98 N (10 kgf) is measured to obtain an average value of 10 target spheres measured.

### Material Hardnesses of Intermediate Layer and Cover

The resin material of each layer is molded into a sheet having a thickness of 2 mm and left for two weeks. Thereafter, the Shore D hardness and the Shore C hardness are measured in accordance with the ASTM D2240 standard. For the measurement of the hardness, a P2 Automatic Rubber Hardness Tester manufactured by Kobunshi Keiki Co., Ltd. is used. Shore D hardness and Shore C hardness attachments are attached to measure each hardness. For the hardness value, a maximum value is read. All measurements are carried out in an environment of 23±2° C.

### Surface Hardness of Intermediate Layer-Encased Sphere

A measurement is performed by perpendicularly pressing the indenter against the surface of the intermediate layer-encased sphere. The Shore D hardness is measured in accordance with the ASTM D2240 standard. For the measurement of the hardness, a P2 Automatic Rubber Hardness Tester manufactured by Kobunshi Keiki Co., Ltd. is used. A Shore D hardness attachment is attached to measure each hardness. For the hardness value, a maximum value is read. All measurements are carried out in an environment of 23±2° C.

TABLE 3

| | | | | | | Comparative | |
|---|---|---|---|---|---|---|---|
| | | Example | | | | Example | |
| | | 1 | 2 | 3 | 4 | 1 | 2 |
| Heat treatment on | Temperature (° C.) | 100 | 100 | 120 | 140 | None | 160 |
| intermediate layer-encased sphere | Time (min) | 10 | 30 | 10 | 10 | None | 10 |
| Heat treatment on ball | Temperature (° C.) | None | None | None | None | None | None |
| | Time (min) | None | None | None | None | None | None |

| Core | Outer diameter (mm) | | 38.70 | 38.70 | 38.70 | 38.70 | 38.70 | 38.70 |
|---|---|---|---|---|---|---|---|---|
| | Weight (g) | | 35.23 | 35.23 | 35.23 | 35.23 | 35.23 | 35.23 |
| | Deflection (mm) | | 3.03 | 3.03 | 3.03 | 3.03 | 3.03 | 3.03 |
| | Hardness | Surface hardness (Cs) | 86.7 | 86.7 | 86.7 | 86.7 | 86.7 | 86.7 |
| | profile | Midpoint between Cs and Cm (Cq) | 79.4 | 79.4 | 79.4 | 79.4 | 79.4 | 79.4 |
| | [Shore C | Hardness (Cm) at midpoint | 68.3 | 68.3 | 68.3 | 68.3 | 68.3 | 68.3 |
| | hardness] | between core center and core surface | | | | | | |
| | | Midpoint between Cm and Cc (Cp) | 67.7 | 67.7 | 67.7 | 67.7 | 67.7 | 67.7 |
| | | Center hardness (Cc) | 66.3 | 66.3 | 66.3 | 66.3 | 66.3 | 66.3 |
| | | Surface − center (Cs − Cc) | 20.4 | 20.4 | 20.4 | 20.4 | 20.4 | 20.4 |
| | | (Cs − Cc)/(Cm − Cc) | 10.3 | 10.3 | 10.3 | 10.3 | 10.3 | 10.3 |

| | | | | | | | |
|---|---|---|---|---|---|---|---|
| Intermediate | Material | No. 1 | No. 1 | No. 1 | No. 1 | No. 1 | No. 1 |
| layer | Melting point (° C.) | 90 | 90 | 90 | 90 | 90 | 90 |
| | Thickness (mm) | 1.18 | 1.17 | 1.17 | 1.17 | 1.18 | 1.18 |
| | Material hardness (Shore D) | 67 | 67 | 67 | 67 | 67 | 67 |
| Intermediate | Outer diameter (mm) | 41.05 | 41.05 | 41.05 | 41.05 | 41.06 | 41.06 |
| layer-encased | Weight (g) | 40.71 | 40.73 | 40.73 | 40.72 | 40.74 | 40.76 |
| sphere | Deflection (mm) | 2.60 | 2.56 | 2.61 | 2.56 | 2.65 | 2.57 |
| | Surface hardness (Shore D) | 71.4 | 71.4 | 71.3 | 71.4 | 70.4 | 71.0 |
| Cover | Material | No. 2 | No. 2 | No. 2 | No. 2 | No. 2 | No. 2 |
| (outermost | Material hardness (Shore D) | 47 | 47 | 47 | 47 | 47 | 47 |
| layer) | Material hardness (Shore C) | 71 | 71 | 71 | 71 | 71 | 71 |
| Ball | Outer diameter (mm) | 42.73 | 42.73 | 42.73 | 42.73 | 42.73 | 42.73 |
| | Weight (g) | 45.56 | 45.60 | 45.57 | 45.59 | 45.57 | 45.60 |
| | Deflection (mm) | 2.45 | 2.41 | 2.45 | 2.41 | 2.45 | 2.41 |

The flights (I #6, HS 40 m/s) and (I #6, HS 35 m/s) and the controllability on approach shots of each golf ball are evaluated by the following methods. The results are shown in Table 4.

### Evaluation of Flight (I #6, HS 40 m/s)

A number six iron (I #6) is mounted on a golf swing robot, and a spin rate when a ball was struck at a head speed (HS) of 40 m/s is measured and rated according to the following criteria. The spin rate immediately after the ball was struck was measured by a device for measuring initial conditions. The club used was a TOURSTAGE X-BLADE CB (2008 model) manufactured by Bridgestone Sports Co., Ltd.

### Rating Criteria

Good: Spin rate compared with Comparative Example 1 is less than −25 rpm
Fair: Spin rate compared with Comparative Example 1 is −25 to +25 rpm
NG: Spin rate compared with Comparative Example 1 is more than ±25 rpm

### Evaluation of Flight (I #6, HS 35 m/s)

A number six iron (I #6) was mounted on the golf swing robot, and a spin rate when the ball was struck at a head speed (HS) of 35 m/s was measured similarly to the above measurement, and rated according to the following criteria. The club used was a TOURSTAGE X-BLADE CB (2008 model) manufactured by Bridgestone Sports Co., Ltd.

### Rating Criteria

Good: Spin rate compared with Comparative Example 1 is less than −25 rpm
Fair: Spin rate compared with Comparative Example 1 is −25 to +25 rpm
NG: Spin rate compared with Comparative Example 1 is more than +25 rpm

### Evaluation of Spin Rate on Approach Shots

A judgment was made based on a spin rate when a sand wedge (SW) was mounted on the golf swing robot and the ball was struck at a head speed (HS) of 14 m/s. The spin rate immediately after the ball was struck was measured by a device for measuring initial conditions. The sand wedge (SW) used was a “TOURSTAGE TW-03 (loft angle) 57° 2002 model” manufactured by Bridgestone Sports Co., Ltd.

### Rating Criteria

Good: Spin rate compared with Comparative Example 1 is at least −25 rpm
NG: Spin rate compared with Comparative Example 1 is less than −25 rpm

TABLE 4

| | | | | | | | Comparative | |
|---|---|---|---|---|---|---|---|---|
| | | | Example | | | | Example | |
| | | | 1 | 2 | 3 | 4 | 1 | 2 |
| Impact | I#6 | Spin rate (rpm) | 6,025 | 5,988 | 5,992 | 5,999 | 6,028 | 6,047 |
| test | HS | Comparison with | −3 | −40 | −36 | −29 | 0 | 19 |
| | 40 m/s | Comparative Example 1 (rpm) | | | | | | |
| | | Rating | Fair | Good | Good | Good | Fair | Fair |
| | I#6 | Spin rate (rpm) | 5,716 | 5,703 | 5,762 | 5,700 | 5,769 | 5,774 |
| | HS | Comparison with | −53 | −67 | −7 | −69 | 0 | 5 |
| | 35 m/s | Comparative Example 1 (rpm) | | | | | | |
| | | Rating | Good | Good | Fair | Good | Fair | Fair |
| | Approach | Spin rate (rpm) | 4,865 | 4,827 | 4,816 | 4,854 | 4,790 | 4,777 |
| | SW | Comparison with | 75 | 37 | 26 | 65 | 0 | −13 |
| | HS | Comparative Example 1 (rpm) | | | | | | |
| | 14 m/s | Rating | Good | Good | Good | Good | Good | Good |

As shown in Table 4, the golf balls of Examples 1 to 4 are obtained by heat-treating the intermediate layer-encased sphere at a temperature in a predetermined range, and it can be seen that the spin rate on full shots with the number six iron is lowered, and the flight performance is improved.

On the other hand, in Comparative Example 1, the ball is encased by injection molding the cover without heat-treating the intermediate layer-encased sphere, and the spin rate on full shots with the number six iron was larger than that in each Example.

In Comparative Example 2, the ball is encased by heat-treating the intermediate layer-encased sphere at 160° C. for 10 minutes, and then injection molding the cover, and the spin rate on full shots with the number six iron was larger than that in each Example.

Japanese Patent Application No. 2023-083711 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A method for manufacturing a golf ball including a core, at least one intermediate layer, and a cover, the core being formed of a rubber material, the intermediate layer being formed of a resin composition, and the cover being formed of a urethane resin material, the method comprising:
a step (1) of forming an intermediate layer-encased sphere by encasing the core with the at least one intermediate layer;
a step (2) of subjecting the intermediate layer-encased sphere to a heat treatment at a temperature of at least a melting point of a base resin of the resin composition of the intermediate layer and less than 160° C.; and
a step (3) of thereafter forming a cover-encased sphere by encasing the intermediate layer-encased sphere with the cover.

2. The manufacturing method of claim 1, wherein in the step (2), the temperature of the heat treatment on the intermediate layer-encased sphere is from 90 to 150° C.

3. The manufacturing method of claim 1, wherein in the step (2), a time of the heat treatment on the intermediate layer-encased sphere is from 3 to 60 minutes.

4. The manufacturing method of claim 1, wherein in the step (1), the intermediate layer-encased sphere is formed by injection molding the resin composition of the intermediate layer around the core.

5. The manufacturing method of claim 1, wherein in the step (3), the cover-encased sphere is formed by injection molding the urethane resin material of the cover around the intermediate layer-encased sphere.

6. The manufacturing method of claim 1, wherein the base resin of the resin composition of the intermediate layer is an ionomer resin.
